(19) United States
(12) Patent Application Publication
(10) Pub. No.: US 2009/0022220 A1
(43) Pub. Date: Jan. 22, 2009

(54) METHOD AND APPARATUS FOR ENHANCED VIDEO CODING

(75) Inventors: Yuri Vatis, Hannover (DE); Bernd Edler, Hannover (DE); Ingolf Wassermann, Hannover (DE); Dieu Thanh Nguyen, Hannover (DE); Joern Ostermann, Hannover (DE)

Correspondence Address: SEED INTELLECTUAL PROPERTY LAW GROUP PLLC, 701 FIFTH AVE, SUITE 5400, SEATTLE, WA, 98104, US

(73) Assignee: UNIVERSITAET HANNOVER, Hannover (DE)

(21) Appl. No.: 11/911,505

(22) PCT Filed: Apr. 13, 2006
(86) PCT No.: PCT/EP2006/003410

§ 371 Date: Aug. 14, 2008

Related U.S. Application Data
(60) Provisional application No. 60/594,494, filed on Apr. 13, 2005.
(60) Provisional application No. 60/595,941, filed on Aug. 19, 2005.

(51) Int. Cl. H04N 7/12

(52) U.S. Cl. 375/240.12; 375/E07.001

(57) ABSTRACT

Standard video compression techniques apply motion-compensated prediction combined with transform coding of the prediction error. In the context of prediction with fractional-pel motion vector resolution it was shown, that aliasing components contained in an image signal are limiting the prediction efficiency obtained by motion compensation. In order to consider aliasing, quantization and motion estimation errors, camera noise, etc., we analytically developed a two dimensional (2D) non-separable interpolation filter, which is independently calculated for each frame by minimizing the prediction error energy. For every fractional-pel position to be interpolated, an individual set of 2D filter coefficients is determined. Since transmitting filter coefficients as side information results in an additional bit rate, which is almost constant for different image resolutions and total bit rates, the loss in coding gain increases when total bit rates sink. Therefore, we developed an algorithm, which regards the non-separable two-dimensional filter as a polyphase filter. For each frame, predicting the interpolation filter impulse response through evaluation of the polyphase filter, we only have to encode the prediction error of the filter coefficients.

The invention relates to methods for encoding and decoding a video signal and corresponding apparatuses.

Coding of video signals is well known in the art and usually related to the MPEG 4 or H.264/AVC standard. The responsible committees for these two standards are the ISO and ITU. In order to reduce the bit rate of video signals, the ISO and ITU coding standards apply hybrid video coding with motion-compensated prediction combined with transform coding of the prediction error. In the first step, the motion-compensated prediction is performed. The temporal redundancy, i.e. the correlation between consecutive images is exploited for the prediction of the current image from already transmitted images. In a second step, the residual error is transform coded, thus the spatial redundancy is reduced.

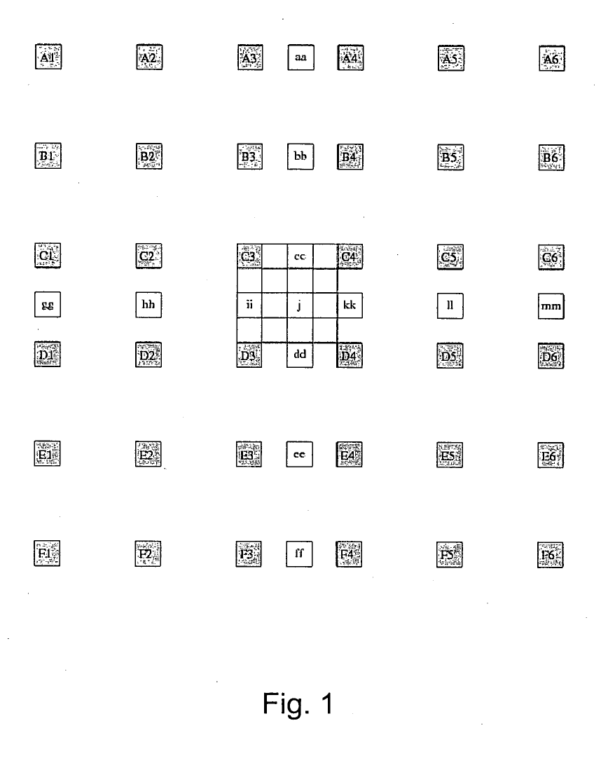

In order to perform the motion-compensated prediction, the current image of a sequence is split into blocks. For each block a displacement vector di is estimated and transmitted that refers to the corresponding position in one of reference images. The displacement vectors may have fractional-pel resolution. Today's standard H.264/AVC allows for ¼-pel displacement resolution. Displacement vectors with fractional-pel resolution may refer to positions in the reference image, which are located between the sampled positions. In order to estimate and compensate the fractional-pel (sub-pel) displacements, the reference image has to be interpolated on the sub-pel positions. H.264/AVC uses a 6-tap Wiener interpolation filter with fixed filter coefficients. The interpolation process used in H.264/AVC is depicted in FIG. 1 and can be subdivided into two steps. At first, the half-pel positions aa, bb, cc, dd, ee, ff and gg, hh, ii, kk, 11, mm are calculated, using a horizontal or vertical 6-tap Wiener filter, respectively. Using the same Wiener filter applied at sub-pel positions aa, bb, cc, dd, ee, ff the sub-pel position j is computed. (Alternatively, the sub-pel position j can be computed using the horizontal filter set applied at sub-pel positions gg, hh, ii, kk, ll, mm). In the second step, the residual quarter-pel positions are obtained, using a bilinear filter, applied at already calculated half-pel positions and existing full-pel positions.

It is an object of the invention to provide a method for encoding and decoding video data in a more effective manner.

The object is solved by the methods according to claim 1, 13, and 21.

Accordingly, a method for encoding a video signal representing a moving picture is provided that comprises the steps of receiving successive frames of a video signal, coding a frame of the video signal, using a reference frame of the video signal, and calculating analytically a value of a sub-pel position of the reference frame by use of a filter having an individual set of two-dimensional filter coefficients. According to this aspect of the invention, instead of calculating the values of sub-pel positions in two steps based on two one-dimensional filters, the pre-sent invention discloses a method of calculating the value of a sub-pel position in a single step by use of a set of two-dimensional filter coefficients.

The filter set can be established by setting up an individual set of equations for the sub-pel position. Accordingly, the calculation is independent for each sub-pel position.

According to an aspect of the invention, some of the two-dimensional filter coefficients are set equal under the constraint that the distance of the corresponding full-pel position to the current sub-pel position for which the two-dimensional filter coefficients are calculated is equal. This contributes to reduce data overhead. Instead of transmitting all filter coefficients, only a reduced number of filter coefficients has to be transmitted.

According to another aspect of the invention, the filter coefficients are coded. The coding may be based on a temporal prediction, wherein the differences of a first filter set with respect to a second filter set have to be transmitted. It is also possible to base the prediction on spatial prediction, wherein the symmetry of the statistical properties of the video signal is exploited. The step of predicting the two-dimensional filter coefficients of a second sub-pel is carried out by the use of an interpolation step with respect to the impulse response of a filter set up of two-dimensional filter coefficients for a first sub-pel, such that the result is used for a second sub-pel. Coding the filter coefficients provides further reduction of the amount of data to be transmitted from an encoder to a decoder.

According to another aspect of the invention, the standard representation form of a filter having one-dimensional filter coefficients is replaced by the corresponding two-dimensional form of the filter. Accordingly, the means provided to encode or decode a video signal can be configured to fulfil only the requirements for a two-dimensional representation form even though two-dimensional and one-dimensional filter sets are used.

The method according to the present invention supports all kinds of filtering, such as for example a Wiener-filter having fixed coefficients. The two-dimensional filter can also be a polyphase filter.

According to an aspect of the invention, different filters are provided for different regions of a picture, such that several sets of filter coefficients can be transmitted and the method comprises the step of indicating which filter set is to be used for a specific region. Accordingly, it is not necessary to transmit all individual sets of filter coefficients, if these sets are identical for different regions. Instead of conveying the data related to the filter coefficients repeatedly from the encoder to the decoder, a single flag or the like is used to select the filter set for a specific region. The region can be a macroblock or a slice. In particular, for a macroblock, it is possible to signal the partition id.

According to another aspect of the invention, a different method for encoding a video signal representing a moving picture by use of a motion compensated prediction is provided. The method includes the steps of receiving successive frames of a video signal, coding a frame of the video signal using a reference frame of the video signal and calculating a value of the sub-pel position independently by minimisation of an optimisation criteria in an adaptive manner. According to this aspect of the invention, the calculation step of a value of sub-pel position is not only carried out independently, but also by minimisation of an optimisation criteria in an adaptive manner. “In an adaptive manner” implies the use of an adaptive algorithm or iteration. Providing an adaptive solution enables the encoder to find an optimum solution with respect to a certain optimisation criteria. The optimisation criteria may vary in time or for different locations of the sub-pel, entailing a continuously adapted optimum solution. This aspect of the invention can be combined with the step of calculating the value of the sub-pel position analytically by use of a filter having an individual set of two-dimensional filter coefficients, such that the filter coefficients are calculated adaptively. The optimisation criteria can be based on the rate distortion measure or on the prediction error energy. The calculation can be carried out by setting up an individual set of equations for the filter coefficients of each sub-pel position. In particular, with respect to the prediction error energy as an optimisation criteria, it is possible to compute first the derivative of the prediction error energy in order to find an optimum solution. The set of two-dimensional filter coefficients can also profit from setting two-dimensional filter coefficients equal for which the distance of the corresponding full-pel position to the current sub-pel position is equal. The step of equating can be based on statistical properties of the video signal, a still picture, or any other criteria. The two-dimensional filter coefficients can be coded by means of temporal prediction, wherein the differences of a first filter set to a second filter set (e.g. used for the previous image or picture or frame) have to be determined. The filter coefficients can also be coded by a spatial prediction, wherein the symmetry of the statistical properties of the video signal is exploited as set out before. The two-dimensional filter can be a polyphase filter.

Different filters can be provided for different regions of a picture, such that several sets of filter coefficients can be transmitted and the method may comprise a step of indicating which filter set is to be used for a specific region. This can be done by a specific flag provided in the coding semantics. The region can be a macroblock or a slice, wherein the partition id can be signalled for each macroblock.

According to another aspect of the invention, a method is provided for encoding and decoding a video signal. The method provides an adaptive filter flag in the syntax of a coding scheme. The adaptive filter flag is suitable to indicate whether a specific filter is used or not. This is particularly useful, since an adaptive filtering step may not be beneficial for all kinds of video signals. Accordingly, a flag (adaptive filter flag) is provided in order to switch on or off the adaptive filter function.

According to another aspect of the invention, a sub-pel is selected for which, among a plurality of sub-pels, a filter coefficient is to be transmitted. This information is included for example in a coding scheme or a coding syntax. Similarly, it can be indicated whether a set of filter coefficients is to be transmitted for the selected sub-pel. This measure takes account of the fact that filter coefficients are not always calculated for all sub-pels. In order to reduce the data overhead, it is possible to transmit only the differences of a present set of filter coefficients with respect to a previous set of filter coefficients. Further, it is possible to code the differences according to entropy coding for any selected sub-pel. The adaptive filter flag can be introduced in the picture parameter set raw byte sequence payload syntax of the coding scheme. This is only one example for a position of an adaptive filter flag in the coding syntax. Other flags may be provided to indicate whether an adaptive filter is used for a current macroblock, another region of a picture, or for B- or P-slices.

The present invention provides also an apparatus for encoding a video signal representing a moving picture by use of motion compensated prediction. An apparatus according to the present invention comprises means for receiving successive frames of a video signal, means for coding the frame of the video signal using a reference frame of the video signal, and means for calculating analytically a value of a sub-pel position of the reference frame by use of a filter having an individual set of two-dimensional filter coefficients.

According to another preferred embodiment, the apparatus according to the present invention may include means for receiving successive frames of a video signal, means for coding a frame of the video signal using a reference frame of the video signal, and means for calculating a value of a sub-pel position independently by minimisation of an optimisation criteria in an adaptive manner.

The present invention provides also a respective method for decoding a coded video signal being encoded according to the method for encoding the video signal as set out above and an apparatus for decoding a coded video signal comprising means to carry out the method for decoding.

The methods and apparatuses for encoding and decoding as well as the coding semantics explained above are applicable to scalable video. It is an aspect of the present invention to provide the methods and apparatuses explained above for scalable video, wherein an independent filter set is used for a layer or a set of layers of the scalable video coding. The filter set for a second layer is predicted from a filter set of a first layer. The layers are typically produced by spatial or temporal decomposition.

These and other aspect of the invention are apparent from and will be elucidated by reference to the embodiments described hereinafter and with respect to the following figures.

FIG. 1 shows a simplified diagram of the pels and sub-pels of an image,

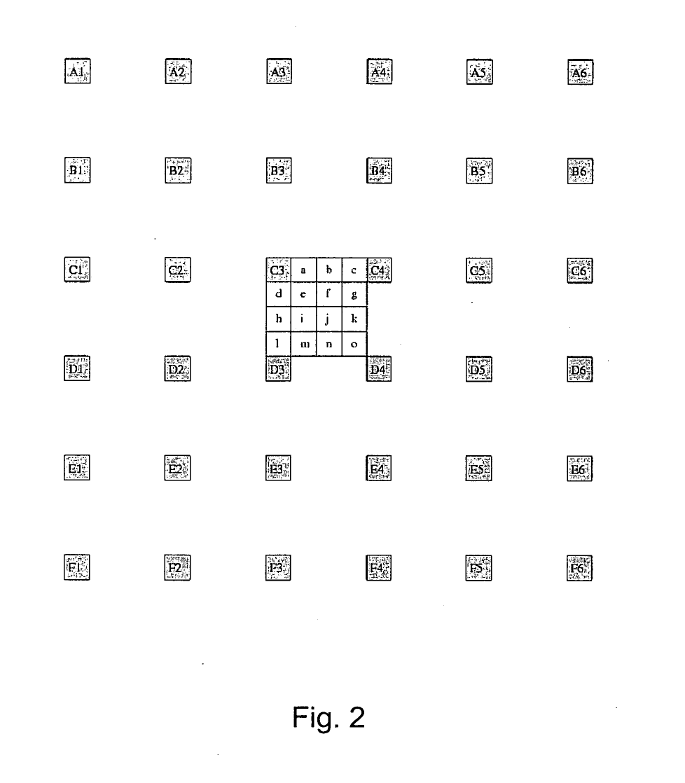

FIG. 2 shows another simplified diagram of the pels an sub-pels of an image,

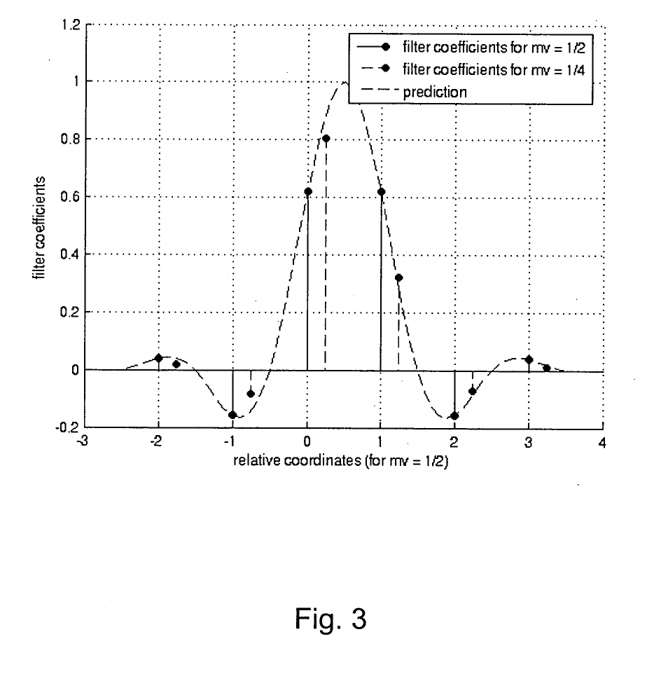

FIG. 3 shows the prediction of the impulse response of a polyphase filter for sub-pel positions,

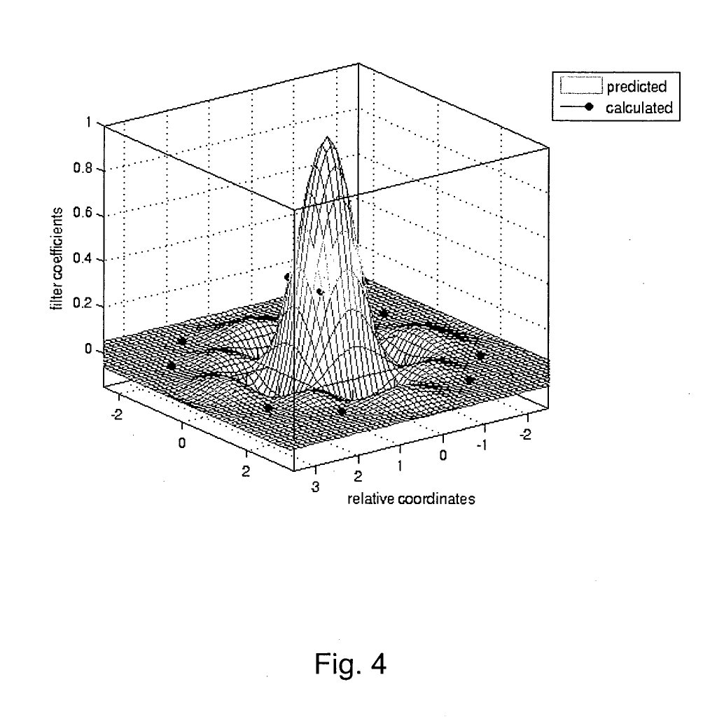

FIG. 4 illustrates an example with interpolated impulse response of a predicted filter at sub-pel position j and calculated filter coefficients, and

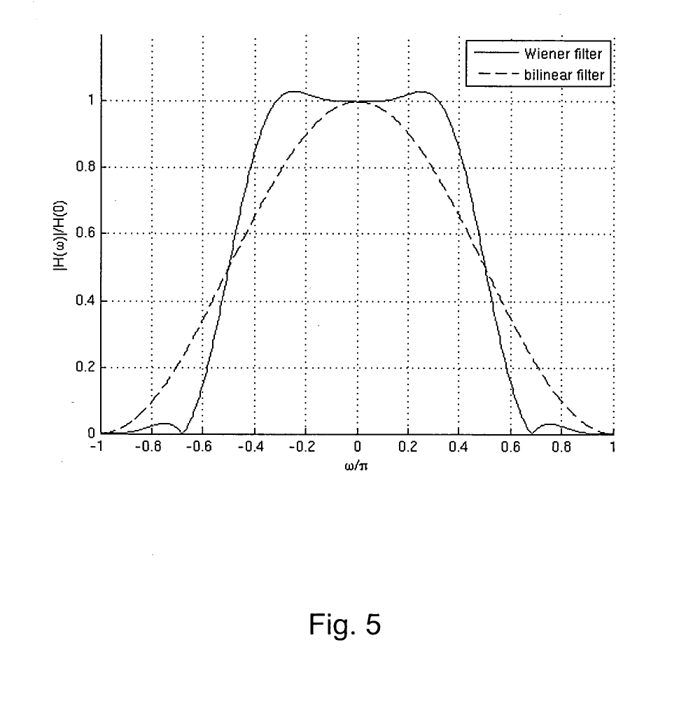

FIG. 5 shows the frequency responses of a Wiener filter, applied at half-pel positions, and a bilinear filter, applied at quarter-pel positions.

The present invention relates to an adaptive interpolation filter, which is independently estimated for every image. This approach enables to take into account the alteration of image signal properties, especially aliasing, on the basis of minimization of the prediction error energy. According to another aspect of the invention, an approach is disclosed for efficient coding of filter coefficients, required especially at low bit rates and videos with low spatial resolution. In the following section, the new scheme of interpolation filter is described. According to a further aspect of the invention, an optimized low-overhead syntax that allows definite filter coefficients decoding is disclosed.

### Non-Separable Two-Dimensional Adaptive Wiener Interpolation Filter

In order to achieve the practical bound for the gain, obtained by means of an adaptive filter, another kind of adaptive filter has been developed. For every sub-pel position SP (a . . . o), see FIG. 2, the individual set of coefficients is analytically calculated, such that no bilinear interpolation is used. If the sub-pel position to be interpolated is located at a, b, c, d, h, l, a one-dimensional 6-tap filter is calculated, using the samples C1-C6 for the sub-pel positions a, b, c and A3-F3 for d, h, l, respectively. For each of the remaining sub-pel positions e, f, g, l, j, k, m, n and o, a two-dimensional 6×6-tap filter is calculated. For all sub-pel positions, the filter coefficients are calculated in a way that an optimization criterion is minimized. The optimization criteria could be the mean squared difference or mean absolute difference between the original and the predicted image signals. Note, that in this proposal we limit the size of the filter to 6×6 and the displacement vector resolution to a quarter-pel, but other filter sizes like 6×4, 4×4, 4×6, 6×1 etc. and displacement vector resolutions are also conceivable with our approach.

In the following, we describe the calculation of the filter coefficients more precisely. Let us assume, that h₀₀^{SP}, h₀₁^{SP}, . . . , h₅₄^{SP}, h₅₅^{SP} are the 36 filter coefficients of a 6×6-tap 2D filter used for a particular sub-pel position SP. Then the value p^{SP} (a . . . o) to be interpolated is computed by a convolution:

$${p}^{SP} = {\sum }_{i = 1}^{6} {\sum }_{j = 1}^{6} {P}_{i , j} {h}_{i - 1 , j - 1}^{SP}$$

where P_{i,j} is an integer sample value (A1 . . . F6).

The calculation of coefficients and the motion compensation are performed in the following steps:
1) Displacement vectors dₜ=(mvx, mvy) are estimated for every image to be coded. For the purpose of interpolation, a first interpolation filter is applied to every reference image. This first interpolation filter could be a fixed one like in the standard H.264/AVC, the filter of the previous image or defined by another method.
2) 2D filter coefficients h_{i,j} are calculated for each sub-pel position SP independently by minimization of the optimization criteria. In a preferred environment we use prediction error energy:

$${( {e}^{SP} )}^{2} = {\sum }_{x} {\sum }_{y} {( {S}_{x , y} - {\sum }_{i} {\sum }_{j} {h}_{i , j}^{SP} {P}_{\tilde{x} + i , \tilde{y} + j} )}^{2}$$

with

\tilde{x}=x+└mvx┘−FO, \tilde{y}=+└mvy┘−FO
where S_{x,y} is an original image, P_{x,y} a previously decoded image, i, j are the filter indices, mvx, mvy are the estimated displacement vector components, FO—a so called Filter Offset caring for centering of the filter and └ . . . ┘—operator is the floor function, which maps the estimated displacement vector mv to the next full-pel position smaller than mv. This is a necessary step, since the previously decoded images contain information only at full-pel positions. Note, for the error minimization, only the sub-pel positions are used, which were referred to by motion vectors. Thus, for each of the sub-pel positions a . . . o an individual set of equations is set up by computing the derivative of (e^{SP})² with respect to the filter coefficient hᵢⱼ^{SP}. The number of equations is equal to the number of filter coefficients used for the current sub-pel position SP.

$$\begin{matrix}0 = \frac{{( \partial {e}^{SP} )}^{2}}{\partial {h}_{k , l}^{SP}} \\ = \frac{\partial }{\partial {h}_{k , l}^{SP}} ( {\sum }_{x} {\sum }_{y} {( {S}_{x , y} - {\sum }_{i} {\sum }_{j} {h}_{i , j}^{SP} {P}_{\tilde{x} + i , \tilde{y} + j} )}^{2} ) \\ = {\sum }_{x} {\sum }_{y} ( {S}_{x , y} - {\sum }_{i} {\sum }_{j} {h}_{i , j}^{SP} {P}_{\tilde{x} + i , \tilde{y} + j} ) {P}_{\tilde{x} + k , \tilde{y} + l}\end{matrix}$$

$$∀ k , l ∈ \{ 0 ; 5 \}$$

For each sub-pel position e, f, g, i, j, k, m, n, o using a 6×6-tap 2D filter, a system of 36 equations with 36 unknowns has to be solved. For the remaining sub-pel positions, requiring a 1D filter, systems of 6 equations have to be solved. This results in 360 filter coefficients (nine 2D filter sets with 36 coefficients each and six 1D filter sets with 6 coefficients per set), which are quantized with accuracy depending on system requirements.
3) New displacement vectors are estimated. For the purpose of interpolation, the adaptive interpolation filter computed in step 2 is applied. This step enables reducing motion estimation errors, caused by aliasing, camera noise, etc. on the one hand and to treat the problem in the rate-distortion sense on the other hand.
4) The steps 2 and 3 can be repeated, until a particular quality improvement threshold is achieved. Since some of the displacement vectors are different after the 3. step, it is conceivable to estimate new filter coefficients, adapted to the new displacement vectors. However, this would result in a higher encoder complexity.

The filter coefficients have to be quantized and transmitted as side information e.g. using an intra/inter-prediction and entropy coding (s. Heading “Prediction and Coding of the Filter Coefficients”).

### Symmetric Two-Dimensional Filter

Since transmitting 360 filter coefficients may result in a high additional bit rate, the coding gain can be drastically reduced, especially for video sequences with small spatial resolution. In order to reduce the side information, we assume that statistical properties of an image signal are symmetric.

Thus, the filter coefficients are assumed to be equal, in case the distance of the corresponding full-pel positions to the current sub-pel position are equal (the distance equality between the pixels in x- and y-direction is also assumed, i.e. if the image signal is interlaced, a scaling factor should be considered etc.).

Let us denote h_{C1}⁸ as a filter coefficient used for computing the interpolated pixel at sub-pel position a at the integer position C1, depicted in FIG. 2. The remaining filter coefficients are derived in the same manner. Then, based on symmetry assumptions only 5 independent 1D or 2D filter sets consisting of different numbers of coefficients are required. Thus, for the sub-pel positions a, c, d, l only one filter with 6 coefficients is estimated, since:

h_{C1}^{a}=h_{A3}^{d}=h_{C6}^{c}=h_{F3}^{l}

h_{C2}^{a}=h_{B3}^{d}=h_{C5}^{c}=h_{E3}^{l}

h_{C3}^{a}=h_{C3}^{d}=h_{C4}^{c}=h_{D3}^{l}

h_{C4}^{a}=h_{D3}^{d}=h_{C3}^{c}=h_{C3}^{l}

h_{C5}^{a}=h_{E3}^{d}=h_{C2}^{c}=h_{B3}^{l}

h_{C6}^{a}=h_{F3}^{d}=h_{C1}^{c}=h_{A3}^{l}

The same assumptions, applied at sub-pel positions b and h result in 3 coefficients for these sub-pel positions:

h_{C1}^{b}=h_{C6}^{b}=h_{A3}^{h}=h_{F3}^{h}

h_{C2}^{b}=h_{C5}^{b}=h_{B3}^{h}=h_{E3}^{h}

h_{C3}^{b}=h_{C4}^{b}=h_{C3}^{h}=h_{D3}^{h}

In the same way, we get 21 filter coefficients for sub-pel positions e, g, m, o 18 filter coefficients for sub-pel positions f, i, k, n and 6 filter coefficients for the sub-pel position j.

h_{A1}^{e}=h_{A6}^{g}=h_{F1}^{m}=h_{F6}^{o}

h_{A2}^{e}=h_{B1}^{e}=h_{A5}^{g}=h_{B6}^{g}=h_{E1}^{m}=h_{F2}^{m}=h_{E6}⁰=h_{F5}^{o}

h_{A3}^{e}=h_{C1}^{e}=h_{A4}^{g}=h_{C6}^{g}=h_{D1}^{m}=h_{F3}^{m}=h_{D6}^{o}=h_{F4}^{o}

h_{A4}^{e}=h_{D1}^{e}=h_{A3}^{g}=h_{D6}^{g}=h_{C1}^{m}=h_{F4}^{m}=h_{C6}^{o}=h_{F3}^{o}

h_{A5}^{e}=h_{E1}^{e}=h_{A2}^{g}=h_{E6}^{g}=h_{B1}^{m}=h_{F5}^{m}=h_{B6}^{o}=h_{F2}^{o}

h_{A6}^{e}=h_{F1}^{e}=h_{A1}^{g}=h_{F6}^{g}=h_{A1}^{m}=h_{F6}^{m}=h_{A6}^{o}=h_{F1}^{o}

h_{B2}^{e}=h_{B5}^{g}=h_{E2}^{m}=h_{E5}^{o}

h_{B3}^{e}=h_{C2}^{e}=h_{B4}^{g}=h_{C5}^{g}=h_{D2}^{m}=h_{E3}^{m}=h_{D5}^{o}=h_{E4}^{o}

h_{B4}^{e}=h_{D2}^{e}=h_{B3}^{g}=h_{D5}^{g}=h_{C2}^{m}=h_{E4}^{m}=h_{C5}^{o}=h_{E3}^{o}

h_{B5}^{e}=h_{E2}^{e}=h_{B2}^{g}=h_{E5}^{g}=h_{B2}^{m}=h_{E5}^{m}=h_{B5}^{o}=h_{E2}^{o}

h_{B6}^{e}=h_{F2}^{e}=h_{B1}^{g}=h_{F5}^{g}=h_{A2}^{m}=h_{E6}^{m}=h_{A5}^{o}=h_{E1}^{o}

h_{C3}^{e}=h_{C4}^{g}=h_{D3}^{m}=h_{D4}^{o}

h_{C4}^{e}=h_{D3}^{e}==h_{C3}^{g}=h_{D4}^{g}=h_{C3}^{m}=h_{D4}^{m}=h_{C4}^{o}=h_{D3}^{o}

h_{C5}^{e}=h_{E3}^{e}=h_{C2}^{g}=h_{E4}^{g}=h_{B3}^{m}=h_{D5}^{m}=C_{B4}^{o}=h_{D2}^{o h}_{C6}^{e}=h_{F3}^{e}=h_{C2}^{g}=h_{F4}^{g}=h_{A3}^{m}=h_{D6}^{m}=h_{A4}^{o}=h_{D1}^{o}

h_{D4}^{e}=h_{D3}^{g}=h_{C4}^{m}=h_{C3}^{o}

h_{D5}^{e}=h_{E4}^{e}=E_{D2}^{g}=h_{E3}^{g}=h_{B4}^{m}=h_{C5}^{m}=h_{B3}^{o}=h_{C2}^{o}

h_{D6}^{e}=h_{F4}^{e}=h_{D1}^{g}=h_{F3}^{g}=h_{A4}^{m}=h_{C6}^{m}=h_{A3}^{o}=h_{C1}^{o}

h_{E5}^{e}=h_{E2}^{g}=h_{B5}^{m}=h_{B2}^{o}

h_{E6}^{e}=h_{F5}^{e}=h_{E1}^{g}=h_{F2}^{g}=h_{A5}^{m}=h_{B6}^{m}=h_{A2}^{o}=h_{B1}^{o h}_{F6}^{e}=h_{F1}^{g}=h_{A6}^{m}=h_{A1}^{o}

h_{A1}^{f}=h_{A6}^{f}=h_{A1}ⁱ=h_{F1}ⁱ=h_{A6}^{k}=h_{F6}^{k}=h_{F1}ⁿ=h_{F6}ⁿ

h_{A2}^{f}=h_{A5}^{f}=h_{B1}ⁱ=h_{E1}ⁱ=h_{B6}^{k}=h_{E6}^{k}=h_{F2}ⁿ=h_{F5}ⁿ

h_{A3}^{f}=h_{A4}^{f}=h_{C1}ⁱ=h_{D1}ⁱ=h_{C6}^{k}=h_{D6}^{k}=h_{F3}ⁿ=h_{F4}ⁿ

h_{B1}^{f}=h_{B6}^{f}=h_{A2}ⁱ=h_{F2}ⁱ=h_{A5}^{k}=h_{F5}^{k}=h_{E1}ⁿ=h_{E6}ⁿ

h_{B2}^{f}=h_{B5}^{f}=h_{B2}ⁱ=h_{E2}ⁱ=h_{B5}^{k}=h_{E5}^{k}=h_{E2}ⁿ=h_{E5}ⁿ

h_{C1}^{f}=h_{C6}^{f}=h_{A3}ⁱ=h_{F3}ⁱ=h_{A4}^{k}=h_{F4}^{k}=h_{D1}ⁿ=h_{D6}ⁿ

h_{C2}^{f}=h_{C5}^{f}=h_{B3}ⁱ=h_{E3}ⁱ=h_{B4}^{k}=h_{E4}^{k}=h_{D2}ⁿ=h_{D5}ⁿ

h_{C3}^{f}=h_{C4}^{f}=h_{C3}ⁱ=h_{D3}ⁱ=h_{C4}^{k}=h_{D4}^{k}=h_{D3}ⁿ=h_{D4}ⁿ

h_{D1}^{f}=h_{D6}^{f}=h_{A4}ⁱ=h_{F4}ⁱ=h_{A3}^{k}=h_{F3}^{k}=h_{C1}ⁿ=h_{C6}ⁿ

h_{D2}^{f}=h_{D5}^{f}=h_{B4}ⁱ=h_{E4}ⁱ=h_{B3}^{k}=h_{E3}^{k}=h_{C2}ⁿ=h_{C5}ⁿ

h_{D3}^{f}=h_{D4}^{f}=h_{C4}ⁱ=h_{D4}ⁱ=h_{C3}^{k}=h_{D3}^{k}=h_{C3}ⁿ=h_{C4}ⁿ

h_{E1}^{f}=h_{E6}^{f}=h_{A5}ⁱ=h_{F5}ⁱ=h_{A2}^{k}=h_{F2}^{k}=h_{B1}ⁿ=h_{B6}ⁿ

h_{E2}^{f}=h_{E5}^{f}=h_{B5}ⁱ=h_{E5}ⁱ=h_{B2}^{k}=h_{E2}^{k}=h_{B2}ⁿ=h_{B5}ⁿ

h_{E3}^{f}=h_{E5}^{f}=h_{B5}ⁱ=h_{E5}ⁱ=h_{B2}^{k}=h_{E2}^{k}=h_{B2}ⁿ=h_{B5}ⁿ

h_{F1}^{f}=h_{F6}^{f}=h_{A6}ⁱ=h_{F6}ⁱ=h_{A2}^{k}=h_{F1}^{k}=h_{A1}ⁿ=h_{A6}ⁿ

h_{F2}^{f}=h_{F5}^{f}=h_{B6}ⁱ=h_{E6}ⁱ=h_{A2}^{k}=h_{F2}^{k}=h_{A2}ⁿ=h_{A5}ⁿ

h_{F3}^{f}=h_{F4}^{f}=h_{C6}ⁱ=h_{D6}ⁱ=h_{A3}^{k}=h_{F3}^{k}=h_{A3}ⁿ=h_{A4}ⁿ

h_{A1}^{j}=h_{A6}^{j}=h_{F1}^{j}=h_{F6}^{j}

h_{A2}^{j}=h_{A5}^{j}=h_{B1}^{j}=h_{B6}^{j}=h_{E1}^{j}=h_{F2}^{j}=h_{E6}^{j}=h_{F5}^{j}

h_{A3}^{j}=h_{A4}^{j}=h_{C1}^{j}=h_{D1}^{j}=h_{D6}^{j}=h_{F3}^{j}=h_{F3}^{j}=h_{F4}^{j}

h_{B2}^{j}=h_{B5}^{j}=h_{E2}^{j}=h_{E5}^{j}

h_{B3}^{j}=h_{B4}^{j}=h_{C2}^{j}=h_{C5}^{j}=h_{D2}^{j}=h_{D5}^{j}=h_{E3}^{j}=h_{E4}^{j}

h_{C3}^{j}=h_{C4}^{j}=h_{D3}^{j}=h_{D4}^{j}

In total, this reduces the number of needed filter coefficients from 360 to 54, exploiting the assumption, that statistical properties of an image signal are symmetric. In following chapter we describe, how the filter coefficients can be predicted and coded. In some cases (e.g. interlaced video), we cannot assume any more, that horizontal and vertical filter sets are equal. Then, vertical and horizontal symmetries independently from each other have to be assumed.

### Prediction and Coding of the Filter Coefficients

After a quantization of the filter coefficients, a combination of two prediction schemes is proposed. The first type is a temporal (inter) prediction, so the differences of the current filter set to the filter set used for the previous image have to be transmitted. This type of coding is applied for filter coefficients at sub-pel positions a and b. The second type is a spatial (intra) prediction. Exploiting the symmetry of statistical properties of an image signal and knowing that no bilinear interpolation is used, coefficients of 2D filters for the different sub-pel positions can be regarded as samples of a common 2D filter, also called as polyphase filter. So, knowing the impulse response of the common filter at particular positions, we can predict its impulse response at other positions by interpolation.

This process is depicted in FIG. 3 for 1D case from the impulse response at half-pel position (sub-pel position b, displacement vector ½), relative coordinates are given in multiple of pixels). Knowing the impulse response of the filter at sub-pel position b, obtained e.g. by means of inter prediction, impulse response of the filter at position a is predicted by interpolation.

Thus, only entropy coded differences have to be transmitted.

So, with h^{a} and h^{b}, and accordingly h^{c}, h^{d}, h^{h} and hⁱ, we can predict 2D filter coefficients by multiplication:

h^{e}=h^{d}·h^{a}

h^{f}=h^{d}·h^{b}

h^{j}=h^{h}·h^{b}

Alternatively, knowing the impulse response of the polyphase filter at particular sub-pel positions, we can predict the impulse response at remaining sub-pel positions applying spline or other interpolation functions.

FIG. 4 illustrates an example with interpolated impulse response of a predicted filter, at sub-pel position j and actually calculated filter coefficients.

### Representation of the Standard Interpolation Filter in 2D Form

In order to reduce complexity, required for realization of two different approaches, the standard separable filter and an adaptive non-separable 2D filter, we propose to bring the standard coefficients into the 2D form. In this case, 15 (if the displacement vector resolution is restricted to quarter-pel) different matrixes containing interpolation filter coefficients have to be stored. For the sub-pel positions a, b, c, d, h, l, located on a row or on a column, only 6 coefficients are used:

a,d^{T}:[1 −5 52 20 −5 1]·2⁻⁶

b,h^{T}:[1 −5 20 20 −5 1]·2⁻⁵

c,l^{T}:[1 −5 20 52 −5 1]·2⁻⁶

For the remaining sub-pel positions, the 2D matrixes with up to 36 coefficients have to be used, which can be derived on the same manner. As an example, a matrix for a position f is given:

$$f \text{:} [ \begin{matrix}1 & - 5 & 20 & 20 & - 5 & 1 \\ - 5 & 25 & - 100 & - 100 & 25 & - 5 \\ 52 & - 260 & 1040 & 1040 & - 260 & 52 \\ 20 & - 100 & 400 & 400 & - 100 & 20 \\ - 5 & 25 & - 100 & - 100 & 25 & - 5 \\ 1 & - 5 & 20 & 20 & - 5 & 1\end{matrix} ] \cdot {2}^{- 11}$$

The matrix coefficients for the sub-pel positions i, n, k can be obtained, when rotating the matrix used for the sub-pel position f by 90°, 180° and 270° in mathematical sense, respectively.

The same can be applied at sub-pel positions e, g, m and o. The coefficient matrix for the sub-pel position e is given as example.

$$e [ \begin{matrix}0 & 0 & 1 & 0 & 0 & 0 \\ 0 & 0 & - 5 & 0 & 0 & 0 \\ 1 & - 5 & 40 & 20 & - 5 & 1 \\ 0 & 0 & 20 & 0 & 0 & 0 \\ 0 & 0 & - 5 & 0 & 0 & 0 \\ 0 & 0 & 1 & 0 & 0 & 0\end{matrix} ] \cdot {2}^{- 6}$$

Replacing the 1D standard filter through the corresponding 2D form would give the following advantages:
1) It is not necessary to implement two interpolations methods, 1D standard and 2D adaptive, if the decoder has to support both methods.
2) Since in the standard, the quarter-pel positions are calculated using already quantized half-pel positions, they are quantized twice. This can be avoided, if the quarter-pel positions are calculated directly.
   Proposal for 2D Wiener Filter with Fixed Coefficients

As already shown, coefficients of 2D filter sets can be regarded as samples of one common 2D filter, sampled at different positions. Since the standard filter as used in H.264 uses a bilinear interpolation for quarter-pel positions, its impulse and frequency response diverges from that of the Wiener filter. In order to show, that the standard interpolation filter applied at quarter-pel positions is far away from the Wiener filter, which is the optimal one, if fixed coefficients are preconditioned, the frequency responses of both, Wiener filter, applied at half-pel positions, and a bilinear filter, applied at quarter-pel positions, are depicted in FIG. 5.

Thus, we propose to use a two-dimensional Wiener filter with fixed coefficients, as described in section “Prediction and Coding of the Filter Coefficients”. By selecting the number of bits used for quantization of filter coefficients, the desired approximation accuracy for the optimal 2D Wiener filter can be achieved. Applying this approach does not require non-separable 2D filter set. Thus, also separable filters can be deployed.

### Different Filters for Different Regions

It is possible, that different parts of an image contain different aliasing components. One reason may be that an image contains different objects, which move differently. Another reason may be that an image contains different textures. Each texture can have different aliasing components. Thus, using different filters which are adapted to different regions can improve the prediction. In this case, we would transmit several sets of filter coefficients. In addition, we would transmit a partition of each image indicating which filter set is valid for that region. A preferred embodiment signals for each macroblock the partition id. Alternatively, this partition could be defined as a slice as used in H.264 or MPEG-4.

### Further Extensions

As we already mentioned, the introduced approach is not restricted to describe settings like quarter-pel motion resolution and 6×6 tap filter size. Depending on requirements, the filter can be either extended to an 8×8-tap filter, what would result in a better prediction quality, but also increase the computational effort, or reduced to a 4×4-tap filter. Using the same techniques described above, we can extend the approach to e.g. ⅛-pel motion resolution. As we showed, it is not necessary to develop extra filter coefficients. Instead of that we can exploit the polyphase structure of the 2D filter and predict the best filter coefficients with a high accuracy.

It is also conceivable to use several filter sets, one for each reference frame. Thus, approach proposed in the section “Non-separable two-dimensional Adaptive Wiener Interpolation Filter” can be applied to each reference frame independently. Though, this would increase side information.

Another extension is defining a set of n predetermined filter sets or n predetermined filters. For each frame, just the index of one or more of the predetermined filter sets is transmitted. Thus, the analytically calculated optimal filter is mapped to the best predetermined filter set or filter of the set. So, only the index of the predetermined filter set or filter (if necessary, entropy coded) needs to be transmitted.

### Syntax and Semantics

This section describes exemplary syntax and semantics which allows the invented scheme to be incorporated into the H.264/AVC standard.

With the introduction of adaptive interpolation filter scheme, the adaptive filter scheme can be switched on or off by the encoder. For this purpose, we introduce in the picture parameter set raw byte sequence payload syntax an adaptive_filter_flag.

TABLE 1

| | | |
|---|---|---|
| pic_parameter_set_rbsp( ){ | C | Descriptor |

.
.
.

| | | |
|---|---|---|
| adaptive_filter_flag | 1 | u(1) |
| if(adaptive_filter_flag) | | |

| | | |
|---|---|---|
| adaptive_filter_flagB | 1 | u(1) |

.
.
.

This code indicates to the decoder, whether the adaptive interpolation scheme is applied for current sequence (adaptive_filter_flag =1) or not (adaptive_filter_flag =0).

adaptive_filter_flagB equal to 1 indicates, that adaptive interpolation scheme is in use for B-slices. adaptive_filter_flagB equal to 0 indicates, that adaptive interpolation scheme is not in use for B-slices.

For all of these slice headers, where the adaptive interplation scheme is in use, the entropy coded filter coefficients are transmitted by the encoder.

TABLE 2

| | | |
|---|---|---|
| slice_header( ){ | C | Descriptor |

.
.
.

if(adaptive_filter_flag && slice_type == P ||

adaptive_filter_flagB && slice_type == B){

| | | |
|---|---|---|
| use_all_subpel_positions | 2 | u(1) |
| if(!use_all_subpel_positions) | | |

| | | |
|---|---|---|
| positions_pattern | 2 | u(v) |

for(sub_pel = 0; sub_pel < 5; sub_pel++)

if(use_all_subpel_positions ||
positions_pattern >> sub_pel)

for( i = 0; i < max_sub_pel_nr
[sub_pel]; i++){

| | | |
|---|---|---|
| DiffFilterCoef[ sub.pel ][ i ] | 2 | se(v) |

}

.
.
.
}

This code indicates to the decoder that if adaptive_filter_flag is set to 1 and current slice is a P-Slice than the entropy coded filter coefficients are transmitted. First, use_all_subpel_positions is transmitted. use_all_subpel_positions equal to 1 specifies that all independent filter subsets are in use. use_all_subpel_positions equal to 0 indicates that not every sub-pel position sub_pel (a . . . o) has been used by the motion estimation tool and positions_pattern is transmitted. positions_pattern[sub_pel] equal to 1 specifies that FilterCoef[sub_pel][i] is in use, whereat FilterCoef represents the actually transmitted optimal filter coefficients.

TABLE 3

| sup_pel position in use | sub_pel | positions_pattern[sub_pel] | | | | |
|---|---|---|---|---|---|---|
| a_pos (c_pos, d_pos, l_pos ) | 0 | 1 | | | | |
| b_pos (h_pos) | 1 | | 1 | | | |
| e_pos (g_pos, m_pos, o_pos) | 2 | | | 1 | | |
| f_pos (i_pos, k_pos, n_pos) | 3 | | | | 1 | |
| j_pos | 4 | | | | | 1 |

Since use_all_subpel_positions signals, if every sub-pel position is in use, positions_pattern cannot be equal to 1111. If use_all_subpel_positions is equal to 0 and the first four entries of positions_pattern are equal to 1, the last entry (j_pos) must be equal to 0 and is not transmitted.

Then, for every sub-pel position where the filter coefficients have been calculated for, the entropy coded (here, using CAVLC) quantized differences (see section “Prediction and Coding of the Filter Coefficients”) DiffFilterCoef are transmitted. Thus, the reconstructed filter coefficients are obtained by adding differences and predicted filter coefficients.

A similar scheme can be applied to a scalable video coder, where for each layer (or for several layers) either independent filter sets or common filter set is used. In case that each layer uses independent filter set, it can be predicted from lower to upper layer.

### Locally-Adaptive Filter

Since applying one adaptive filter set for the entire image results only in averaged improvements, it does not necessarily mean, that every macroblock is coded more efficiently. To ensure the best coding efficiency for every macroblock, an additional step at the encoder can be performed, whereby for each macroblock two filter sets, the standard and the adaptive one are compared. For these macroblocks where the adaptive filter is better (e.g. in terms of rate-distortion criterion), a new filter is calculated and only this one is transmitted. For the remaining macroblocks, the standard interpolation filter is applied. In order to signal, if the adaptive or the standard filter is applied to the current macroblock, an additional flag has to be transmitted for each macroblock.

TABLE 4

| | | |
|---|---|---|
| macroblock_layer( ){ | C | Descriptor |

.
.
.

if(adaptive_filter_flag && slice_type == P ||

adaptive_filter_flagB && slice_type == B)

| | | |
|---|---|---|
| adaptive_filter_in_current_mb | 2 | u(1) |

.
.
.
}

adaptive filter_in_current_mb equal to 1 specifies, that adaptive filter is in use for current macroblock. adaptive_filter_in_current_mb equal to 0 specifies, that standard (fixed) filter is in use for current macroblock.

Alternatively, another adaptive filter can be calculated for all these macroblocks, where standard (fixed) filter has been chosen. The filter coefficients of this filter are transmitted in the same manner, described in previous section. In that case, adaptive_filter_in_current_mb flag would switch between two filter sets. adaptive_filter_in_current_mb flag can be predicted from neighboring already decoded macroblock so that only the prediction error for adaptive filter_in_current_mb flag is transmitted. If entropy coding is used (e.g. arithmetic coding, CABAC), this flag can be coded with less than 1 bit/flag.

In some cases, e.g. if an image consists of different textures, it is conceivable to use several independent filters. These can be either for every image independently calculated filter coefficient sets or choosing one of a set of pre-defined filter sets, or combination of both. For this purpose, for each macroblock (or set of e.g. neighbor macroblocks), a filter number has to be transmitted. Furthermore, this filter set can be predicted starting from neighboring already decoded macroblocks. Thus, only entropy coded differences (CAVLC, CABAC) have to be transmitted.

The present invention is beneficial for a broad variety of applications such as digital cinema, video coding, digital TV, DVD, blue ray, HDTV, scalable video. All these applications will profit from one or more aspects of the present invention. The present invention is in particular dedicated to improving the MPEG 4 Part 10 H.264/AVC standard. In order to enhance coding schemes and coding syntax of these standards, particular semantics are disclosed which may comply with the standard requirements. However, the basic principle of the present invention should not be constrained to any particular syntax given on the previous pages, but will be acknowledged by the person skilled in the art in a much broader sense.

1. Method for encoding a video signal representing a moving picture by use of motion compensated prediction, the method comprising the steps of:
receiving successive frames of a video signal,
coding a frame of the video signal using a reference frame of the video signal, and
calculating analytically a value of a sub-pel position (p^{SP}(a . . . o)) of the reference frame by use of a filter having an individual set of two-dimensional filter coefficients.

2. Method according to claim 1 comprising further the step of setting up an individual set of equations for the sub-pel position (a . . . o).

3. Method according to claim 1 comprising the step of setting two-dimensional filter coefficients equal for which the distance of the corresponding full-pel position to the current sub-pel position.

4. Method according to claim 1 comprising the step of coding the filter coefficients.

5. Method according to claim 4, wherein the step of coding the filter coefficients uses a temporal prediction, wherein the difference of a first filter coefficient with respect to a second filter coefficient used for a previous image is transmitted.

6. Method according to claim 4, wherein the coding applied for filter coefficients is a spatial prediction comprising the steps of:
exploiting the symmetry of statistical properties of the video signal, and
predicting the two-dimensional filter coefficients of a second sub-pel by interpolating the impulse response of a filter set up of two-dimensional filter coefficients for a first sub-pel.

7. Method according to claim 1 comprising further the step of
replacing the standard representation form of a filter having one-dimensional filter coefficients by the corresponding two-dimensional form of the filter.

8. Method according to claim 1, wherein the two-dimensional filter coefficients are filter coefficients for a Wiener-filter having fixed coefficients.

9. Method according to claim 1, wherein the two-dimensional filter is a poly-phase filter.

10. Method according to claim 1, wherein plural sets of filter coefficients are provided for a picture and the method comprises the step of indicating which filter set is to be used.

11. Method according to claim 10, wherein the region is a macroblock and the step of indicating comprises signalling for each macroblock the partition id.

12. Method according to claim 10, wherein the region is a slice.

13. Method for encoding a video signal representing a moving picture by use of motion compensated prediction, the method comprising the steps of:
receiving successive frames of a video signal,
coding a frame of the video signal using a reference frame of the video signal, and
calculating a value of a sub-pel position independently by minimization of an optimization criteria in an adaptive manner.

14. Method according to claim 13, wherein the step of calculating comprises analytically calculating the value of a sub-pel position (p^{SP}(a . . . o)) of the reference frame by use of a filter having an individual set of two-dimensional filter coefficients.

15. Method according to claim 13, wherein the optimization criteria is based on the rate distortion measure.

16. Method according to claim 13 wherein the optimization criteria is based on the prediction error energy.

17. Method according to claim 16 comprising further the step of computing the derivative of the prediction error energy.

18. Method according to claim 14 comprising the step of setting two-dimensional filter coefficients equal for which the distance of the corresponding full-pel position to the current sub-pel position is equal.

19. Method according to claim 13 comprising the steps of
coding the filter coefficients,
using a temporal prediction, wherein the difference of a first filter coefficient with respect to a second filter coefficient used for the previous image is transmitted.

20. Method according to claim 13, comprising the step of coding the filter coefficients, wherein the coding of the filter coefficients is a spatial pre-diction comprising the steps of
exploiting the symmetry of statistical properties of the video signal, and
predicting the two-dimensional filter coefficients of a second sub-pel by interpolating the impulse response of a filter set up of two-dimensional filter coefficients for a first sub-pel.

21. Method for encoding and decoding a video signal, comprising the steps of
providing an adaptive filter flag in the syntax of a coding scheme, the adaptive filter flag being suitable to indicate whether a specific filter is used or not.

22. Method according to claim 21, comprising the step of
selecting a sub-pel for which a filter coefficient or a set of filter coefficients is to be transmitted.

23. Method according to claim 22, comprising further the steps of
determining the differences of a first set of filter coefficients with respect to a second set of filter coefficients for the selected sub-pel, and
entropy coding of the differences.

24. Method according to claim 21, wherein the adaptive filter flag is introduced in the picture parameter set raw byte sequence payload syntax of the coding scheme.

25. Method according to claim 21, comprising the step of indicating by a flag in the syntax of the coding scheme that an adaptive filter is in use for the current macroblock.

26. Apparatus for encoding a video signal representing a moving picture by use of motion compensated prediction, the apparatus comprising:
means for receiving successive frames of a video signal,
means for coding a frame of the video signal using a reference frame of the video signal, and
means for calculating analytically a value of a sub-pel position (p^{SP}(a . . . o)) of the reference frame by use of a filter having an individual set of two-dimensional filter coefficients.

27. Apparatus for encoding a video signal representing a moving picture by use of motion compensated prediction, the apparatus comprising:
means for receiving successive frames of a video signal,
means for coding a frame of the video signal using a reference frame of the video signal, and
means for calculating a value of a sub-pel position independently by minimization of an optimization criteria in an adaptive manner.

28. Method for decoding a coded video signal being coded according to the method of claims 1.

29. Apparatus for decoding a coded video signal comprising means to carry out the method of claim 28.

30. Method according to claim 1 being applied to scalable video.

31. Method according to claim 30, wherein an independent filter set is used for a layer or for a set of layers, and wherein the layers are determined by spatial and/or temporal decomposition.

32. Method according to claim 31, wherein the filter set for a first layer is predicted from a filter set of a second layer.
